(19) United States
(12) Patent Application Publication
(10) Pub. No.: US 2025/0020216 A1
(43) Pub. Date: Jan. 16, 2025

(54) HEATER OPTIMIZED BALL VALVE

(71) Applicant: A & N Corporation, Williston, FL (US)

(72) Inventor: Adam Scott Davis, Bronson, FL (US)

(21) Appl. No.: 18/771,785

(22) Filed: Jul. 12, 2024

Related U.S. Application Data
(60) Provisional application No. 63/526,184, filed on Jul. 12, 2023.

(51) Int. Cl. F16K 1/14; F16K 31/44; F16K 51/02

(52) U.S. Cl. CPC F16K 1/14; F16K 31/44; F16K 51/02

(57) ABSTRACT

Provided is a heater optimized ball valve that includes one or more heat-through components. The heater optimized ball valve may be a modular ball valve that includes a plurality of end caps secured to a valve body frame with a ball disposed within the frame between at least two of the end caps, wherein the modular ball valve comprises a thermally conductive grease that includes a mixture of a vacuum grease and a metal-alloy powder disposed on a top outer-diameter surface of the ball and on an inner proximal-facing surface of a top end cap at least partially filling a top gap that separates the two surfaces, and on a bottom outer diameter surface of the ball valve and on a distal-facing surface of a bottom end cap at least partially filling a gap that separates the two surfaces.

### CROSS-REFERENCE TO RELATED APPLICATIONS

This application claims priority to U.S. Provisional Patent Application Ser. No. 63/526, 184, filed Jul. 12, 2023, the entirety of which is incorporated herein by reference.

### FIELD

This disclosure is generally directed to ball valves, more specifically vacuum system ball valves.

### BACKGROUND

Choosing a suitable valve to control the flow is paramount in vacuum systems and processes. When selecting the correct valve, various options like gate valves, poppet valves, butterfly valves, pendulum valves, and ball valves often come into consideration. An unfortunate drawback to many of these options is that internal components are exposed to contaminants during valve actuation. Residual gases can get trapped in these areas, cause virtual leaks, and increase the wear on valve components. These effects can cause costly changes in maintenance schedules and system operation.

A ball valve is one of several types of “quarter-turn” closing valves. Such valves are usually held between two sealed connections and operate by the turning of a ball inside a valve body. The ball has a through hole or port that can be lined up with the open ends of the valve to permit flow. When the ball is turned, by an attached handle or other actuator, the port becomes smaller and blocks flow through the valve. Usually, if the ball is turned a full 90°, the port becomes perpendicular to the ends of the valve and blocks flow entirely. Variations can utilize a ball with more than one port, known as a multi-port, such that when the valve is turned, flow is redirected through a different valve and further turning can close off flow entirely.

The ball valve is a desirable isolation valve designed to direct the flow of gases and other materials within a vacuum system. Ball valves are desirable for use in industry because they enable quick opening and a leak-proof closed seal. However, ball valves used in industrial applications are often exposed to various chemical compounds, liquid or gaseous, that can have a corrosive effect on the components, which can compromise the internal seals. The ball valve's simple, straight-through design and ability to perform a self-cleaning function during the ball's actuation against PTFE seats partially mitigate these effects. However, one of the critical problems with traditional ball valves is their susceptibility to leakage.

A valve, such as a multiport valve, can include a stem subassembly. The stem subassembly contains moving parts, it is subject to wear and is often the first place that undesirable performance issues arise. During the actuation of these valves, issues arise due to unstable stems and less-than-optimal stem seal designs. These factors contribute to unwanted leaks, which can be both a nuisance and a financial burden. Leaks not only disrupt system operation but also lead to increased maintenance costs. A common implementation of stem seals to those skilled in the art is an O-ring. For the purposes of this discussion, the terms stem seal and O-ring are interchangeable. Most often, the seals between the central valve stem and the stem seal are the most vulnerable.

It is also not unusual for ball valves used in industry to be exposed to excessive temperatures (below 0° F. to over 1000° F.) and pressure (10⁻¹⁰ mmHg to over 100 PSI). But elevated temperatures are particularly problematic and can have the greatest effect because of expansion of the stem seal material. Various specialized metallic or elastomeric materials have been developed to withstand the chemical or environmental extremes for each application. Valve body designs have also been improved to accommodate for stem seal expansion within the valve gland.

The ball in a typical ball valve is very well insulated from the rest of the valve, and only makes contact with polymer seats that have very low thermal conductivity and a stem that makes poor thermal contact with the rest of the valve. Nonetheless, maintaining elevated temperatures of inner surfaces of vacuum systems is important and providing better heat transfer to the ball reduces or eliminates cold spots in the bore of the ball that would otherwise lead to clogging of the valve from the freezing or deposition of the process chemistry flowing through the valve. This increases the time intervals between required maintenance, which reduces the total downtime of the line. It also reduces the exposure of potentially hazardous process chemistry to maintenance personnel since the lines require maintenance less often and will have less clogging.

Conventional ball valves are limited by the shortcomings of unwanted leaks due to unstable stems and less-than-optimal stem seal designs. Additionally, conventional ball valves are limited by inefficient heat transfer due to their stem's poor thermal contact with the rest of the valve components and valve body configurations that effectively insulate the ball. What is needed in the art, therefore, is an improved ball valve with thermal components.

### SUMMARY

In an embodiment, there is a thermally conductive grease. The thermally conductive grease includes a mixture of a vacuum grease and a powder. The powder includes a metal, a metal alloy or both.

In an embodiment, there is a heater optimized ball valve, such as a heater optimized modular ball valve. The modular ball valve includes a valve body frame, a plurality of end caps, a ball disposed within a volume of the frame, and a valve stem assembly. The valve body frame includes an inner surface and an outer surface. The outer surface has at least two side faces, a top face, and a bottom face. The at least two side faces include a first side face and a second side face. The plurality of end caps are secured to the frame and include a first end cap, a second end cap, a bottom end cap and a top end cap. The first end cap includes a first seat and is secured to the first side face. The second end cap includes a second seat and is secured to the second side face. The ball is disposed between the first seat and the second seat. The ball includes a top outer-diameter surface, a bottom outer-diameter surface, and a valve stem slot. The bottom end cap is secured to the bottom face of the valve body frame. The top end cap includes a through-hole and is secured to the top face of the valve body frame. The through-hole extends between a proximal surface of the top end cap and a distal surface of the top end cap. The valve stem assembly includes valve stem. The valve stem includes a distal end, a proximal end and a stem body frame that extends between the distal end and the proximal end. The stem's proximal end is engaged with the valve stem slot. The stem extends through the through-hole.

In an embodiment, there is a method for making a modular ball valve. The method includes providing a valve body frame comprising at least two side faces, a top face and a bottom face. The method includes securing a first end cap that has a first seat to a first one of the at least two side faces of the valve body frame. The method includes securing a second end cap that has a second seat to a second one of the at least two side faces of the valve body frame. The method includes securing a ball between the first seat and the second seat. The method includes securing a bottom end cap to the bottom face of the valve body frame, wherein the bottom end cap has a bottom distal-facing heat transfer surface that extends substantially concentrically with at least a portion of bottom outer-diameter of the ball, and is separated from the at least the portion of the bottom outer-diameter surface by a bottom gap. The method includes securing a top end cap that has a through-hole to the top face of the valve body frame, wherein the top end cap has a top proximal-facing heat transfer surface that substantially aligns concentrically with at least an upper outer-diameter surface of the ball and is separated from the upper outer-diameter surface by a top gap. The method includes inserting a valve stem through the through-hole. The valve stem includes a distal end, a proximal end and a stem body that extends between the distal and the proximal end, wherein the proximal end is engaged with the valve stem slot, and wherein the stem body extends through the through hole. The method includes delivering a volume of thermally conductive grease to substantially occupy at least one of the bottom gap and the top gap, wherein the thermally conductive grease comprises a mixture of a vacuum grease and a powder that includes a metal, a metal alloy or both.

In another embodiment there is a stem subassembly kit. The stem subassembly kit includes a top end cap that has a through hole, wherein the top end cap includes a top proximal-facing heat transfer surface that, when attached to a ball valve, substantially aligns concentrically with at least an upper outer-diameter surface of the ball and is separated from the upper outer-diameter surface by a top gap, and wherein the through hole extends between a proximal surface of the top end cap and a distal surface of the top end cap. The stem subassembly kit includes a valve stem having a distal end, a proximal end and a stem body that extends between the distal and the proximal end, wherein the stem body extends through the through hole, and wherein the valve stem is connected to the top end cap. The stem subassembly kit includes a volume of thermally conductive grease. The thermally conductive grease includes a mixture of a vacuum grease and a powder. The powder includes a metal, a metal alloy or both.

In an embodiment there is a method for servicing a ball valve. The method can include providing a ball valve comprising a ball, a top end cap secured to a top face of a valve body and a stem, wherein the stem is disposed through a through hole of the top end cap and secured to the top end cap; removing the top end cap with the stem still secured to it; providing a stem subassembly kit, wherein the stem subassembly kit comprises a subassembly kit top end cap comprising a through hole, wherein the through hole extends between a proximal surface of the top end cap and a distal surface of the top end cap, and further comprising a stem secured to the subassembly top end cap and extending through the through hole; securing the stem subassembly kit top end cap to the top face of the valve body.

Advantages of at least one embodiment include a heater optimized ball valve configured for efficient heat transfer through the valve body to the ball while minimizing heat loss through the valve's stem and actuator. An advantage of at least one embodiment includes a ball valve configured for efficient heating of the ball which helps prevent byproduct buildup and deposition inside the ball, thus reducing costly maintenance and downtime, for example, of high-vacuum systems used in semiconductor and other manufacturing. An advantage of an embodiment includes a ball valve comprising a fully ported ball to provide maximum conductance with minimum to no restriction in flow path to reduce particle buildup. An advantage of an embodiment includes a ball valve as disclosed herein that includes recessed fasteners and flat surfaces that provide improved heat transfer from an external heating element. A further advantage of at least one embodiment described herein is a ball valve configured with a valve stem housing that can be replaced (i.e., swapped out or serviced) in the field.

Additional advantages of the embodiments will be set forth in part in the description which follows, and in part will be understood from the description, or may be learned by practice of the invention. The advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 is a perspective view of a modular ball valve according to an embodiment.

FIG. 2A is perspective partial cross-sectional view of the modular ball valve shown in FIG. 1.

FIG. 2B is a side view of the modular ball valve shown in FIG. 2A.

FIG. 2C is a cross-sectional view of the ball valve shown in FIG. 2A.

FIG. 3 is a perspective view of a valve body frame of the modular ball valve shown in FIGS. 1-2C.

FIG. 4 is an exploded perspective view of the modular ball valve shown in FIGS. 1-2C.

FIG. 5 is a perspective partial cross-sectional view of a stem subassembly of an embodiment.

FIGS. 6A-6B are top and bottom exploded perspective views, respectively, of the stem subassembly of FIG. 5.

FIG. 7A is perspective exploded view of a ball valve stem according to an embodiment.

FIG. 7B is a cross-sectional view of the ball valve stem shown in FIG. 6A.

FIG. 8A is perspective exploded view of a ball valve stem according to an embodiment.

FIG. 8B is a cross-sectional view of the ball valve stem shown in FIG. 8A.

FIGS. 9A-9B are side views of a manual ball valve according to an embodiment.

FIGS. 10A-10B are side views of a pneumatic ball valve according to an embodiment.

### DETAILED DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

The following embodiments are described for illustrative purposes only with reference to the Figures. Those of skill in the art will appreciate that the following description is exemplary in nature, and that various modifications to the parameters set forth herein could be made without departing from the scope of the present invention. It is intended that the specification and examples be considered as examples only. The various embodiments are not necessarily mutually exclusive, as some embodiments can be combined with one or more other embodiments to form new embodiments.

In an embodiment of the present disclosure, there is a thermally conductive grease. The thermally conductive grease may include a composition comprising a mixture of a vacuum grease and a powder comprising a metal, a metal alloy or both. The powder can include a plurality of metal particles, metal alloy particles, or both. In an embodiment, the metal alloy comprises stainless steel, for example, a stainless steel powder comprising a plurality of stainless steel particles. As compared to conventional vacuum greases, use of mixture of a vacuum grease and a powder comprising a metal, a metal alloy or both, advantageously boosts thermal conductivity of the grease without introducing any additional chemical compatibility issues.

The plurality of metal alloy particles can have an average particle size of from about 4 microns to about 150 microns.

In an embodiment, the thermally conductive grease composition comprises a grease-to-particle ratio of from about 1:1 to about 1:4, including from about 1:1 to about 1:3 by weight.

Examples of vacuum grease to be used in the thermally conductive grease composition of embodiments are not limited and may include one or more of commercially available vacuum grease (e.g., 85% Dimethyl siloxane, trimethylysiloxy-terminated, 10% Silicon dioxide, 5% Dimethyl siloxane, hydroxy-terminated) such as DOW CORNING® High Vacuum grease available from Dow Corning Corporation of Midland, MI, a vacuum grease based on a perflouoropolyether oil thickened with a tetrafluoroethylene gelling agent and extreme pressure additive such as CASTROL® Braycote 803 available from Castrol Industrial North America, Inc. of Naperville, IL, or TORRLUBE® ExtremeGrease available from The Torrlube Company, LLC of Vandenberg Village, CA.

In an example, the thermally conductive grease comprises a mixture of a vacuum grease based on a perflouoropolyether oil thickened with a tetrafluoroethylene gelling agent and extreme pressure additive, and a stainless steel based powder, where the particles that form the powder have an average particle size of about 15 microns, and wherein the thermally conductive grease comprises a mixture in a 1:3 ratio by weight.

Embodiments of the thermally conductive grease described herein may be provided as a stand-alone product, such as provided in a container. Alternatively, the thermally conductive grease of the embodiments may be provided pre-applied onto surfaces, such on swappable components used as replacements for in-field servicing.

In an embodiment of the present disclosure, a modular ball valve may include a valve body frame to which at least one end cap, including a plurality of endcaps, may be secured. More specifically, a modular ball valve can include a valve body frame comprising an inner surface and an outer surface. The outer surface may include at least two side faces, a top face and a bottom face, wherein the at least two side faces comprise a first side face and a second side face. The inner surface may include at least two inner side surfaces, an inner top surface and an inner bottom surface. The valve body frame may further comprise a plurality of openings that each extends from the inner surface to the outer surface. The plurality of openings may comprise a top opening that extends from the inner top surface to the top face, a bottom opening that extends from the inner bottom surface to the bottom face, and at least two side openings comprising a first side opening that extends from a first of the two inner side faces to a first of the two side faces and a second side opening that extends from a second of the two inner side faces to a second of the two side faces.

The modular ball valve can include a first end cap secured to the valve body frame, for example, secured to the first side face. A first seat can be provided in a corresponding pocket as a portion of the first end cap that receives at least a portion of the first seat. Accordingly, the first end cap can include the first seat already secured thereto and then be secured to the valve body frame, or the seat can be secured to the first end cap after the first end cap is secured to the valve body frame's first side face. The modular ball valve can further include a second end cap secured to the valve body frame, for example, secured to the second side face. A second seat can be provided in a corresponding pocket machined as a portion of the second end cap that receives at least a portion of the second seat. Accordingly, the second end cap can include the second seat already secured thereto and then be secured to the valve body frame, or the seat can be secured to the second end cap after the second end cap is secured to the valve body frame, for example, secured to the second side face.

In an embodiment, the valve stem comprises a distal portion, a proximal portion and a body frame that extends between the distal and proximal portions. The stem can comprise a thermally insulating stem. For example, stem body frame may comprise at least a hollow portion. Thus, the stem body frame may comprise an inner diameter, an outer diameter and a sidewall that extends from the inner diameter to the outer diameter. As described above, the stem body frame can include a distal portion and a proximal portion. In an embodiment, the stem's distal end is welded to the stem body frame's distal portion. In an embodiment, the stem's proximal end extends from the stem body frame's proximal portion and wherein the proximal end and stem body frame comprise a single, machined part. In an embodiment, the stem's distal portion, body frame and proximal portion all comprise a single, machined part with no welding required. In an embodiment, the modular ball valve comprises a fastening nut, wherein the distal end of the stem comprises a threaded portion and the stem is connected to the top end cap with the fastening nut threaded along the threaded portion of the stem. The stem may be provided as part of a stem subassembly that comprises the stem and the top end cap. The stem subassembly may be provided pre-assembled, or in individual pieces that are assembled during assembly of the modular ball valve or during servicing.

The modular valve can include a ball disposed between the first seat and the second seat. The ball can include a top outer-diameter surface such as toward a top polar region of the ball. The ball can include a bottom outer-diameter surface such as toward a bottom polar region of the ball. The ball can include a valve stem slot. The modular ball valve can include a valve stem comprising a distal end, a proximal end and a stem body frame that extends between the distal end and the proximal end, wherein the proximal end is engaged with the valve stem slot of the ball, and wherein the stem body frame extends through the through hole of the top end cap. Accordingly, the valve stem slot can be a machined slot configured to receive and engage with the stem's distal end such that when the stem is manipulated, it can translate such manipulation to cause the ball to move (i.e., rotate). The ball may be a fully ported ball. The fully ported ball may be configured as an I-port, x-port, L-port, T-port, vertical L-port, vertical T-port, double L-port, and double T-port.

The modular ball valve can include a bottom end cap secured to the bottom face of the valve body frame. The modular ball valve can include a top end cap comprising a through hole and secured to the top face of the valve body frame. The through hole can extend between a proximal surface of the top end cap and a distal surface of the top end cap. The bottom end cap may further comprise a bottom distal-facing heat transfer surface that extends substantially concentrically with at least a bottom outer-diameter surface of the ball and is separated from the bottom outer-diameter surface by a bottom gap, wherein the top end cap further comprises a top proximal-facing heat transfer surface that extends substantially concentrically with at least an upper outer-diameter surface of the ball and is separated from the upper outer-diameter surface by a top gap. Additionally, the bottom end cap can include a bottom body port end cap. The bottom body port end cap can include a bore that extends through at least a portion thereof. In an embodiment, the bottom distal-facing heat transfer surface comprises an annular surface disposed concentric with a diameter of the bore. In an embodiment, any one of the first end cap, second end cap, bottom end cap and top end cap can be separately removed from the valve body frame and replaced with a respective one of a corresponding replacement end cap, such as may be required during servicing of the ball valve. The top proximal-facing heat transfer surface comprises an annular surface disposed concentric with a diameter of the through hole.

The stem may be attached to the top end cap using various components. Accordingly, the modular ball valve may further include a lower bearing disposed at a proximal portion of the top end cap on a sidewall portion of the through hole, an upper bearing disposed at a distal portion of the top end cap on the sidewall portion of the through hole, an O-ring disposed between the upper bearing and the lower bearing; a wave spring washer disposed distal to the upper bearing and a retaining ring disposed distally to the wave spring washer, wherein the stem extends through the lower bearing, O-ring, upper bearing, wave spring washer and retaining ring.

Top and bottom end caps of the modular ball valve of the embodiments can be referred to as “heat-thru” components as they include surfaces that extend inward toward and are configured with surface geometries that are concentric with the ball geometry, such as its outside surface. These concentric surfaces of the top and bottom end caps may not come into direct physical contact the ball surface, though their geometries are not limited to only those that do not come into direct contact with the ball surface, but they may extend just short of physical contact with the ball surface so as to provide at least one gap between the surface of the end caps and the ball surface. Providing a gap limits resistance and possible damage that would otherwise be caused by the metal ball contacting the metal surface of the end caps. However, such a gap results in a thermal break with high resistance to heat transfer. Thus, to assist with minimizing such a thermal break and increasing thermal conductivity, the at least one gap may be at least partially occupied by a thermally conductive grease, such as a thermally conductive grease of the embodiments described herein. Accordingly, when the outer surfaces of the modular ball valve are heated, such as via an external heat source included an electric resistive heater jacket, a surface heater and/or heating cords, the heat flows from the external heat source inward to the ball and is assisted by the thermally conductive grease.

In an embodiment, the modular valve can include a volume of thermally conductive grease, such as the thermally conductive grease of embodiments described above, applied to surfaces thereof. For example, thermally conductive grease can be provided so as to substantially occupy, that is to be disposed in at least a portion of at least one of the bottom gap and the top gap. Thermally conductive grease can be provided to substantially contact at least one of the bottom distal-facing heat transfer surface and the top proximal-facing heat transfer surface. Thermally conductive grease can be provided to substantially contact at least one of the bottom outer-diameter of the ball and the upper outer-diameter surface of the ball. As described above, the thermally conductive grease may comprise a mixture of a vacuum grease and a powder comprising a metal, a metal alloy or both. The metal alloy powder can include a plurality of metal particles, metal alloy particles, or both. The plurality of metal alloy particles can include a particle size of from about 4 microns to about 150 microns. The thermally conductive grease composition can include a grease-to-particle ratio of from 1:1 to about 1:4 by weight, including a ratio of from 1:1 to about 1:3 by weight. The metal alloy can include stainless steel.

In an embodiment, the modular valve is configured as a 2-way valve (i.e., an isolation valve). In an embodiment, the modular valve is configured as a multi-port valve. In an embodiment, the modular valve is configured as a 3-way valve. In an embodiment the modular valve is configured as a 4-way valve. In an embodiment, the modular valve is configured as a 5-way valve.

In an embodiment, the valve body frame is configured as a cube-shaped valve body frame. In an embodiment, the cube-shaped valve body frame comprises 6 side faces. In an embodiment, at least one of the first end cap and the second end cap comprise a blank end cap fastened to one of the 6 side faces.

In an embodiment, at least one of the valve body frame, first end cap, second end cap, ball, bottom end cap, top end cap and stem substantially comprise a metal alloy. In an embodiment, each of the valve body frame, first end cap, second end cap, ball, bottom end cap, top end cap and stem substantially comprise a metal alloy.

In an embodiment, the modular ball valve comprises a handle attached to the distal end of the stem and adapted to transfer rotational motion to the ball. In an embodiment, the modular ball valve comprises an actuator attached to the distal end of the stem and adapted to transfer rotational motion to the ball.

At least one of the first side face, the second side face, the top face and the bottom face comprises fastener accepting holes and wherein at least one of the top end cap, bottom end cap, first end cap and second end cap comprises fastener through holes that align with the fastener accepting holes.

In embodiments, the modular ball valve may further include a mounting adaptor secured to the top end cap.

Generally, the modular valve of the embodiments is assembled by first fastening the end caps to the valve body frame with the ball disposed between valve seats. Next, the appropriate volume of thermally conductive grease is applied to the “heat-thru” components. With the ball held in position by the valve seats, the “heat-thru” components are fastened to the valve, thereby spreading out the thermally conductive grease to fill the gaps between the ball and “heat-thru” components.

In an embodiment, there is a method for making a modular ball valve, comprising: providing a valve body frame comprising at least two side faces, a top face and a bottom face; securing a first end cap comprising a first seat to a first one of the at least two side faces of the valve body frame; securing a second end cap comprising a second seat to a second one of the at least two side faces of the valve body frame; securing a ball between the first seat and the second seat; securing a bottom end cap to the bottom face of the valve body frame, wherein the bottom end cap comprises a bottom distal-facing heat transfer surface that extends substantially concentrically with at least a portion of bottom outer-diameter of the ball and is separated from the at least the portion of the bottom outer-diameter surface by a bottom gap; securing a top end cap comprising a through hole to the top face of the valve body frame, wherein the top end cap comprises a top proximal-facing heat transfer surface that substantially aligns concentrically with at least an upper outer-diameter surface of the ball and is separated from the upper outer-diameter surface by a top gap; inserting a valve stem through the through hole, the valve stem comprising a distal end, a proximal end and a stem body that extends between the distal and the proximal end, wherein the proximal end is engaged with the valve stem slot, and wherein the stem body extends through the through hole; and delivering a volume of thermally conductive grease to substantially occupy at least one of the bottom gap and the top gap, wherein the thermally conductive grease comprises a mixture of a vacuum grease and a metal, a metal alloy or both.

In another embodiment there is a valve, such as a multiport valve, that can include a swappable valve stem subassembly. The swappable valve stem subassembly may comprise a valve stem, a stem housing, a sealing element (such as at least one O-ring), lubricating grease, and at least one bearing (e.g., an upper bearing and/or a lower bearing) that support the valve stem. The swappable valve stem subassembly may also include a washer (e.g., a wave spring washer) and a retaining ring for securing the stem to the stem housing. In an embodiment, the valve stem may be threaded and secured to the stem housing with a nut, for example, instead of the retaining ring and spring washer combination. In an embodiment, the swappable valve stem subassembly can be swapped out in the field. The swappable valve stem housing subassembly allows for quick servicing in the field by allowing maintenance personnel to quickly swap out the subassembly for a new or previously serviced subassembly. Accordingly, one option for servicing a valve, such as a multiport valve, is to provide a kit that includes a swappable stem subassembly. This reduces system downtime (i.e., reduces the time that a line is down for maintenance).

The heat transfer component on the top of the valve can also serve as the housing for the valve stem assembly, which contains the valve stem, the sealing element, such as an O-ring, the lubricating grease, and the bearings that support the valve stem. Being that this subassembly contains moving parts, it is subject to wear and is often the first place that undesirable performance issues arise. This subassembly can be quickly swapped out in the field to alleviate an issue, thereby reducing the time that a line down for maintenance.

Embodiments described herein may be applicable in embodiments of a method for servicing a modular valve. Such a method can include the following actions: providing a ball valve comprising a stem, a ball, and a top end cap secured to a top face of a valve body frame, wherein the stem is disposed through a through hole of the top end cap and secured to the top end cap; removing, from the valve body frame, the top end cap with the stem still secured to it; providing a stem subassembly kit, wherein the stem subassembly kit comprises: a subassembly kit top end cap comprising a through hole, wherein the through hole extends between a proximal surface of the top end cap and a distal surface of the top end cap, and further comprising a stem secured to the subassembly top end cap and extending through the through hole; and securing the stem subassembly kit top end cap to the top face of the valve body frame.

In such a method for servicing a modular valve, the subassembly kit top end cap comprises a top proximal-facing heat transfer surface that, when the subassembly kit top end cap is attached to the top face of the valve, substantially aligns concentrically with at least an upper outer-diameter surface of the ball and is separated from the upper outer-diameter surface by a top gap. The method can further comprise providing a volume of thermally conductive grease to the top proximal-facing heat transfer surface of the subassembly kit top end cap, wherein the thermally conductive grease comprises a mixture of a vacuum grease and a powder comprising metal particles, metal alloy particles, or both. In the method for servicing a modular valve, the thermally conductive grease composition may comprise a grease-to-particle ratio of from 1:1 to about 1:4 by weight including a grease-to-particle ratio of from 1:1 to about 1:3 by weight.

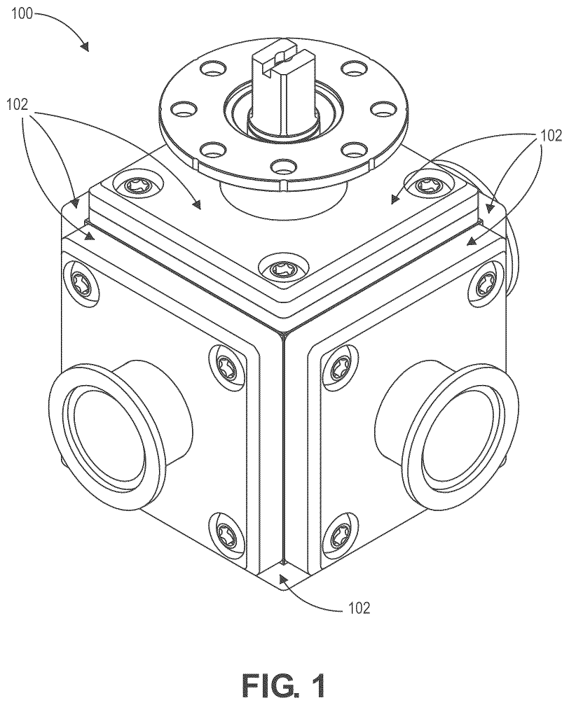

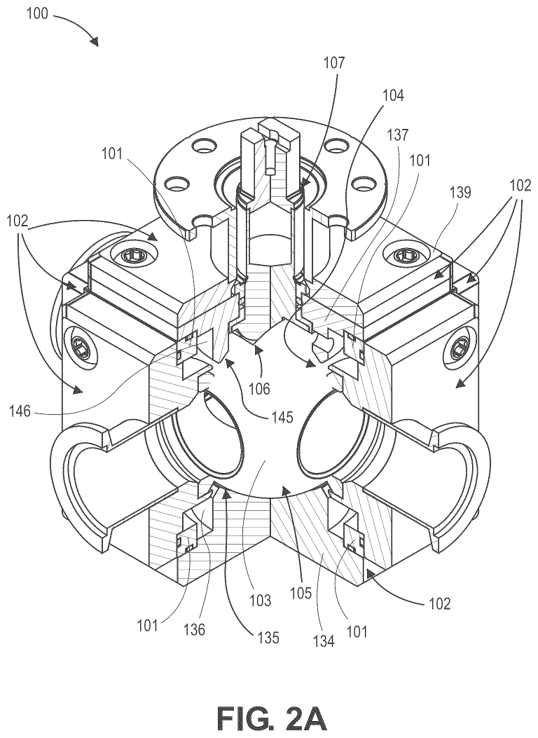

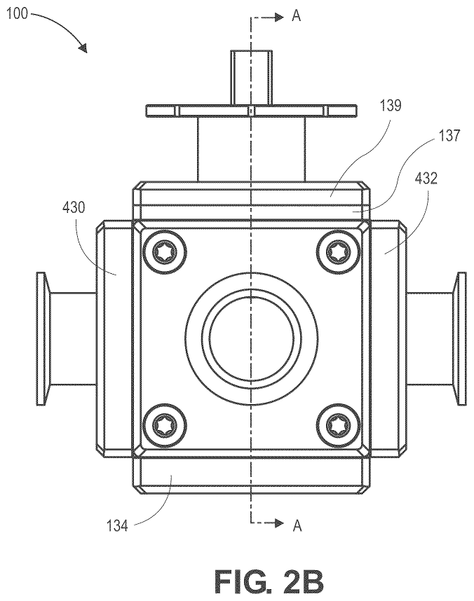

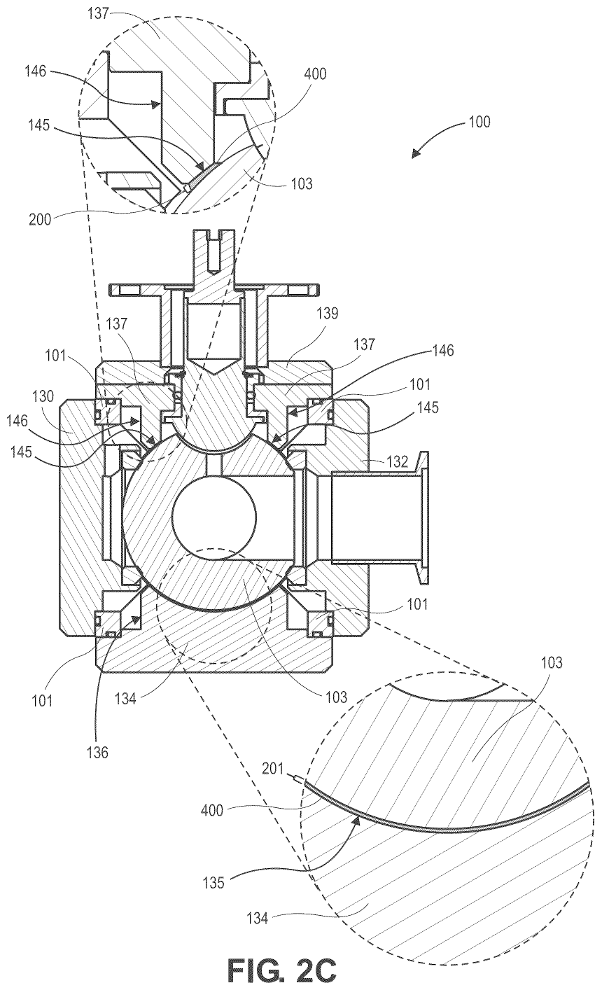

As shown in FIG. 1, an embodiment of a modular ball valve 100 includes a plurality of end caps 102 and in the partial cut-through perspective view of FIG. 2A, the plurality of endcaps 102 are shown secured to the valve body frame 101 with a ball 102 disposed within the frame 101, wherein the ball 103 comprises a top outer-diameter surface 104 toward an upper polar region of the ball 103, a bottom outer diameter surface 105 toward a lower polar region of the ball 103, and a valve stem slot 106 at the top polar region of the ball valve 103. The valve 100 further includes a valve stem assembly 107 which may incorporate one of the plurality of endcaps 102 as a housing portion thereof as described below.

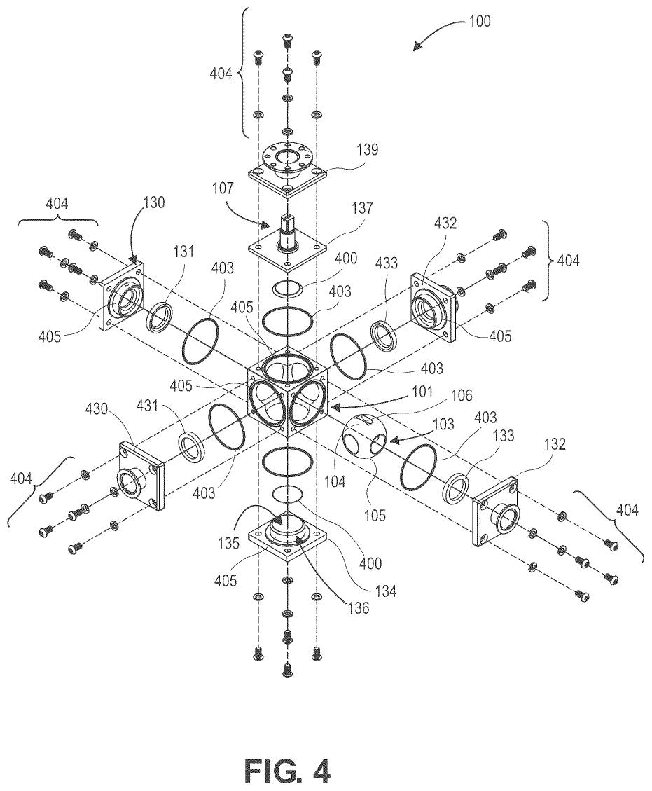

The plurality of endcaps, such as the plurality of endcaps 102 of FIG. 1 and FIG. 2A, can include at least a first endcap and a second endcap, but can further include a third endcap, a fourth endcap (for a total of four side endcaps on a cube-shaped valve frame), along with an upper endcap and a lower endcap. For example, as shown in more detail in FIGS. 2B-2C, the plurality of endcaps 102 can include a first endcap 130, a second endcap 132, a bottom endcap 134 and a top end cap 137, with each individually secured to the frame 101. In some instances, the end cap may be a “blank” end cap that does not include a through-hole. For example, in valve 100 is shown as a three-way valve thus requiring that only three of four side endcaps each be configured with a through-hole that terminates in a short segment of tubing and/or a flange. Thus, end cap 130 is shown as a blank, while end caps 132, 430 and 432 (as in FIG. 4) are shown as comprising through-holes. Additionally, bottom end cap 134 is also shown as a blank end cap while valve stem subassembly 107 is shown with an integrated housing secured to the valve frame 101 as a top end cap 137 that comprises a through-hole through which the stem extends. An adaptor end cap 139 may be additionally secured to the valve with the top end cap 137 disposed between the adaptor end cap 139 and the valve frame 101. The modular ball valve can further include a first seat and a second seat, as well as a ball disposed between the first seat and the second seat.

The top end cap 137 further comprises a top proximal-facing heat transfer surface 145 that extends substantially concentrically with at least an upper outer-diameter surface 104 of the ball and is separated from the upper outer-diameter surface 104 by a top gap 200. The top end cap 137 further comprises a cylindrical surface 146 that extends between a base portion of the top end cap 137 and the proximal-facing heat transfer surface 145, concentric with a diameter of a corresponding through hole that extends from an outer surface to an inner surface at the top of valve body frame 101. That is, the top proximal-facing heat transfer surface 145 comprises a cylindrical surface 146 disposed concentric with a diameter of the through hole of the valve body frame 101. The top end cap may further comprise a bore disposed as a through hole through which the stem extends through.

The bottom end cap 134 further comprises a bottom distal-facing heat transfer surface 135 that extends substantially concentrically with at least a lower outer-diameter surface 105 of the ball and is separated from the lower outer-diameter surface 105 by a bottom gap 201. The bottom end cap 134 further comprises a cylindrical surface 136 that extends between a base portion of the bottom end cap 134 and the distal-facing heat transfer surface 135, concentric with a diameter of a corresponding through hole that extends from an outer surface to an inner surface at the bottom of valve body frame 101. That is, the bottom distal-facing heat transfer surface 135 comprises a cylindrical surface 136 disposed concentric with a diameter of the through hole of the valve body frame 101. While not illustrated here, bottom end cap 134 may be configured as a bottom body port end cap that comprises a bore configured as a through-hole that extends from the distal-facing surface through the base portion of the bottom portion of the end cap (similar to the through hole for the top end-cap, but configured for a port such as the first and second end caps) In the case of the bottom body port end cap configuration, the bottom distal-facing heat transfer surface's annular surface is disposed to further be concentric with a diameter of the bore.

As described above and as shown in more detail in the insets at FIG. 2C, a volume of thermally conductive grease 400 is provided on at least a portion of top outer-diameter surface 104 of ball valve 103, and/or on at least a portion of a proximal-facing heat transfer surface 145 of top end cap 137 at top gap 200, and/or a separate volume of thermally conductive grease 400 is provided on at least a portion of bottom outer-diameter surface 105 of ball valve 103, and/or on at least a portion of a distal-facing heat transfer surface 135 of bottom end cap 134 at bottom gap 201.

The top gap 200 is at least partially defined by a distance between the top proximal-facing heat transfer surface 145 of the top end cap 137 and the upper outer-diameter surface 104 of the ball 103, and comprises a length of between about 0% to about 20% of the ball diameter, for example from about 0% to about 10% of the ball diameter, such as from about 0.1% to about 10% of the ball diameter, including from about 2% to about 3% of the ball diameter.

The bottom gap 201 is at least partially defined by a distance between the bottom distal-facing heat transfer surface 135 of the bottom end cap 134 and the bottom outer-diameter surface 105 of the ball 103, and comprises a length of between about 0% to about 20% of the ball diameter, for example from about 0% to about 10% of the ball diameter, such as from about 0.1% to about 10% of the ball diameter, including from about 2% to about 3% of the ball diameter.

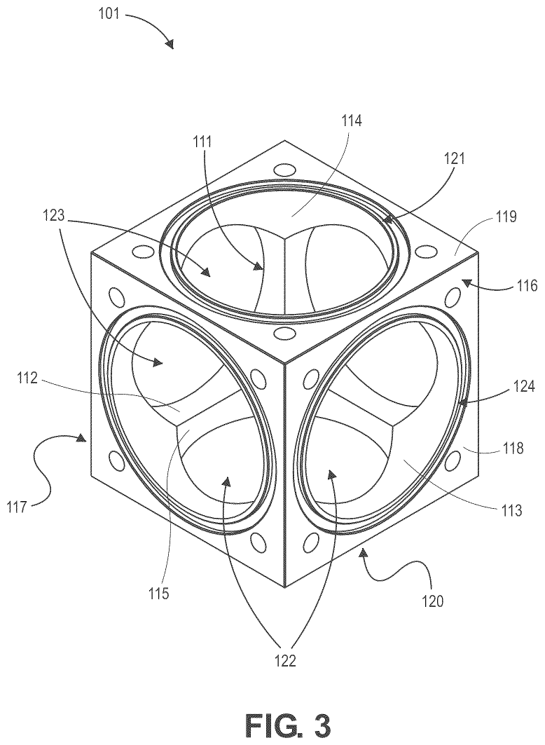

Turning to FIG. 3, valve body frame 101 is illustrated in perspective view. As shown, valve body frame 101 has an inner surface 111. The inner surface includes at least two inner side faces, such as first inner side surface 112 and second inner side surface 113, an inner top surface 114 and an inner bottom surface 115. The outer surface 116 includes at least two side faces, such as first side face 117 and second side face 118, a top face 119 and a bottom face 120. Valve body frame 111 further comprises a plurality of openings that extend from the inner surface 111 to the outer surface 116. The plurality of openings include a top opening 121 that extends from the inner top surface 114 to the top face 119, a bottom opening 122 that extends from the inner bottom surface 115 to the bottom face 120, and at least two side openings comprising a first side opening 123 that extends from a first 112 of the two inner side faces to a first 117 of the two side faces and a second side opening 124 that extends from a second 113 of the two inner side faces to a second 118 of the two side faces.

In an example illustrated in FIG. 4 which shows an exploded view of modular ball valve 100. As shown, the valve body frame 101 and/or at least one of the end caps such as first end cap 130, second end cap 132, third end cap 430, fourth end cap 430, bottom end cap 134, and top end cap 137 include a corresponding O-ring groove 405 to which a corresponding O-ring 403 is inserted. The first end cap 130 comprises a first seat 131 is secured to the first side face (not visible in this view) of frame 101 using fasteners 404 which extend through holes in the first end cap 130 and are received by corresponding holes in first side face of the frame 101 with an O-ring 403 disposed between the first end cap 130 and valve body frame 101. A second end cap 132 comprising a second seat 133 is secured to the second side face of frame 101 using fasteners 404 which extend through holes in the second end cap 132 and are received by corresponding holes in the second side face of the frame 101 with an O-ring 403 disposed between the second end cap 132 and valve body frame 101. A third end cap 430 comprising a third seat 431 is secured to the third side face (not visible in this view) of frame 101 using fasteners 404 which extend through holes in the third end cap 430 and are received by corresponding holes in the third side face of frame 101 with an O-ring 403 disposed between the third end cap 430 and valve body frame 101. A fourth end cap 432 comprising a fourth seat 433 is secured to the fourth side face of frame 101 using fasteners 404 which extend through holes in the fourth end cap 432 and are received by corresponding holes in the fourth side face of the frame 101 with an O-ring 403 disposed between the fourth end cap 432 and valve body frame 101. Notably, the fasteners 404 may include recessed fasteners that are received by recessed slots in the end caps which can provide for additional heat-transfer efficiency from an external heat source to the internal components, such as the ball valve. For example, the fasteners 404 may include threaded fasteners comprising recessed fastener heads.

Ball 103 is placed within frame 101 to be disposed at least between the first seat 131 and the second seat 133. As discussed above, a volume of thermally conductive grease 400 is provided at the top gap (not visible in FIG. 4) on at least a portion of a proximal-facing heat transfer surface 145 (not visible in FIG. 4) of top end cap 137 and on at least a portion of the upper outer-diameter surface 104 of the ball 103, and/or a separate volume of thermally conductive grease 400 is provided at the bottom gap (not visible in FIG. 4) on at least a portion of bottom outer-diameter surface 105 of ball 103. Notably, though FIG. 4 shows a ball valve that comprises top and bottom end caps with heat-thru features (such as the top proximal-facing heat transfer surface and the bottom distal-facing heat transfer surface), in an embodiment there is a ball valve that includes a top end cap that does not comprise a top proximal-facing heat transfer surface and a bottom end cap that does comprise a bottom distal-facing heat transfer surface, and in another embodiment there is a ball valve that includes a top end cap that does comprise a top proximal-facing heat transfer surface and a bottom end cap that does not comprise a bottom distal-facing heat transfer surface.

In an embodiment there is a method for making a modular ball valve which can be illustrated by reference to the exploded perspective view provided in FIG. 4 with reference to FIGS. 1, 2A, 2B, 2C and 3. The method includes providing valve body frame 101 comprising at least two side faces 117, 118, a top face 119 and a bottom face 120. The metho further includes securing a first end cap 130 comprising a first seat 131 to a first one 117 of the at least two side faces of the valve body frame 101. The method further includes securing a second end cap 132 comprising a second seat 133 to a second one 118 of the at least two side faces of the valve body frame 101. The method further includes securing a ball 103 between the first seat 131 and the second seat 133. The method further includes securing a bottom end cap 134 to the bottom face 120 of the valve body frame 101, wherein the bottom end cap 134 comprises a bottom distal-facing heat transfer surface 135 that extends substantially concentrically with at least a portion of bottom outer-diameter 105 of the ball 103 and is separated from the at least the portion of the bottom outer-diameter surface by a bottom gap 201; securing a top end cap 137 comprising a through hole to the top face 119 of the valve body frame 101, wherein the top end cap 137 comprises a top proximal-facing heat transfer surface (not visible in FIG. 4) that substantially aligns concentrically with at least an upper outer-diameter surface of the ball and is separated from the upper outer-diameter surface by a top gap 200. The method includes providing a volume of thermally conductive grease 400 to substantially occupy at least one of the bottom gap 201 and the top gap 200, wherein the thermally conductive grease comprises a mixture of a vacuum grease and a metal, a metal alloy or both.

As mentioned briefly above, top end cap may comprise a through hole that is secured to the top face of the valve body frame, wherein the through hole extends between a proximal surface of the top end cap and a distal surface of the top end cap; and a valve stem comprising a distal end, a proximal end and a stem body frame that extends between the distal and the proximal end, wherein the proximal end is engaged with the valve stem slot, and wherein the stem body frame extends through the through hole.

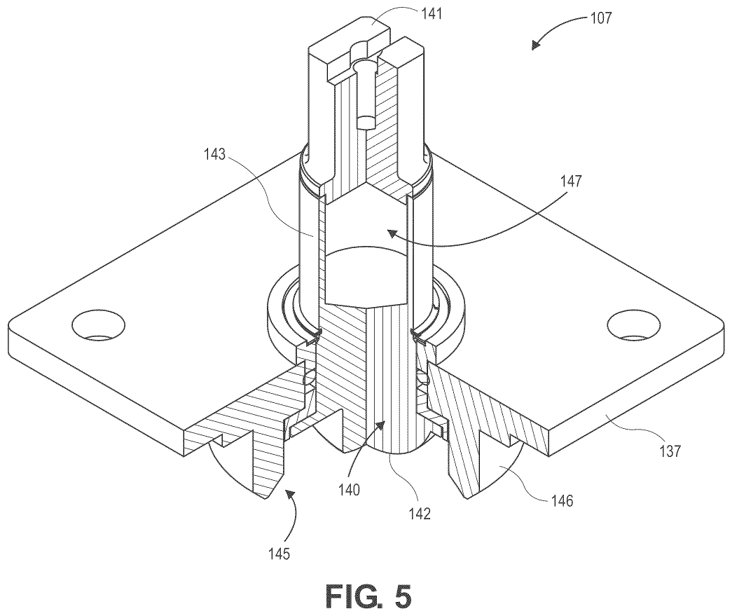

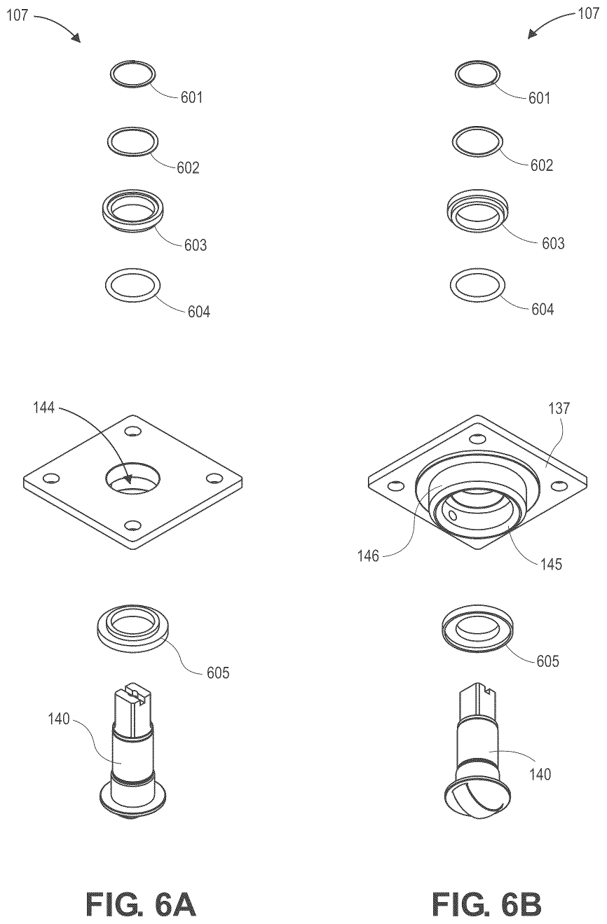

The top end cap may be provided as a component of a stem subassembly, such as stem subassembly 107 shown as perspective partial sectioned view in FIGS. 5 and downward perspective exploded view of FIG. 6A and upward perspective exploded view of FIG. 6B. As illustrated.

The stem subassembly may be pre-assembled so as to be provided as part of a stem subassembly kit, or may be assembled during the course of assembly of the modular ball valves of the embodiment. The stem subassembly 107 can include a lower bearing 605 disposed at a proximal portion of the top end cap 137 on a sidewall portion of the through hole 144, an upper bearing 603 disposed at a distal portion of the top end cap 137 on the sidewall portion of the through hole 144, an O-ring 604 disposed between the upper bearing 603 and the lower bearing 605; a wave spring washer 602 disposed distal to the upper bearing 603 and a retaining ring 601 disposed distally to the wave spring washer 602, wherein the stem 140 extends through the lower bearing 605, O-ring 604, upper bearing 603, wave spring washer 602 and retaining ring 601.

Accordingly, where a stem subassembly is not provided pre-assembled, in the method for making a modular ball valve as described above there may be additional steps, including: inserting the valve stem 140 through an inner diameter of the lower bearing 605 and inserting the valve stem 140 through the through hole 144 of top end plate 137. Further components of the stem subassembly may be added around the stem 140, including O-ring 604, upper bearing 603, wave spring washer 602 and retaining ring 601.

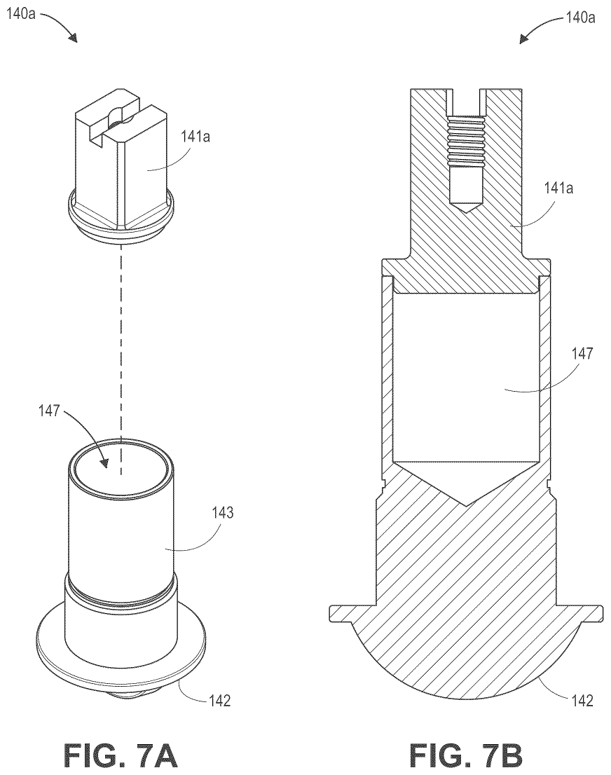

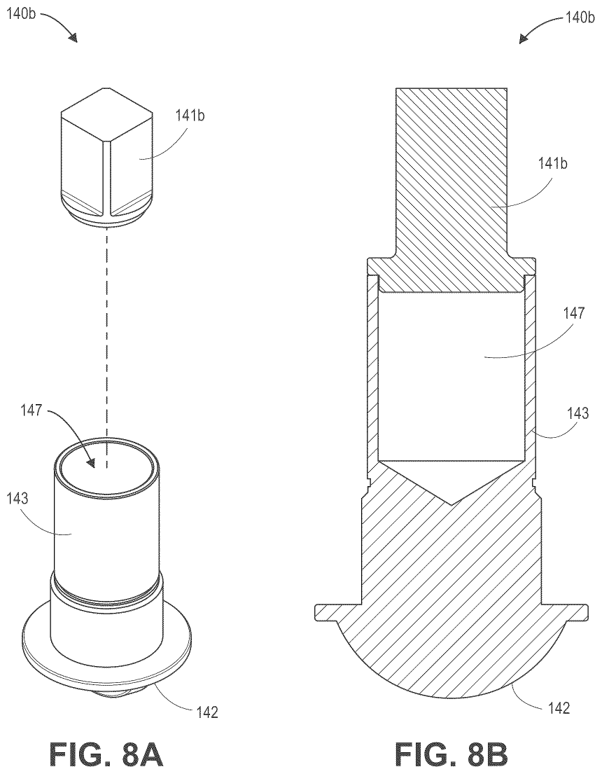

As previously mentioned and now illustrated in more detail in FIGS. 7A-7B and FIGS. 8A-8B, the valve stem 140 may comprise a distal end 141, a proximal end 142, and a stem body 143 that extends between the distal end 141 and the proximal end 142.

In embodiments, the valve stem used in the modular ball valve may include at a hollow portion to reduce the heat transfer though it, while still configured to carry the torsion and bending loads to which it will be subjected during actuation. Accordingly, as shown in FIGS. 7A, 7B, 8A, and 8B, a center portion 147 of the stem is hollow. This preserves the ability of the valve stem to carry the torsional and bending loads to which it will be subjected, while also reducing the cross-sectional area, and therefore the thermal conductance of the valve stem. This reduces the heat loss from the valve, as the actuation devices that are attached to the valve stem, either directly or indirectly, act as heat sinks that bleed off heat to the ambient air.

In embodiments where an actuation device comprising a handle is used for actuating the ball valve, stem 140a having a threaded bored distal end 141a (as shown in FIGS. 7A-7B) for accepting a fastener may be used in the stem subassembly 107.

In embodiments where an actuation device comprising a pneumatic actuator is used for actuating the ball valve, stem 140b having a squared distal end 141b (as shown in FIGS. 8A-8B) for inserting into a stem receiving end of a coupler or directly into a stem receiving end of the actuator may be used in the stem subassembly 107.

As described above, the stem for use in embodiments of the modular ball valve disclosed herein may be provided as a two-piece welded construction or may be machined as a single unit. Regardless of fabrication method, lower proximal portion of the stem possesses the features that engage with the ball of the modular ball valve while a hollow portion of the body limits heat transfer. The upper distal portion of the stem is designed to engage with standardized actuation devices (handles, pneumatic actuators, etc.), and in some embodiments has features that can be mated to standardized position indication devices. The upper component of the valve stem can be made in different sizes to match the standardized drive sizes of valve actuators so that multiple sizes and/or makes of actuator could be utilized (for example, include but are not limited to 17 mm and 19 mm drives).

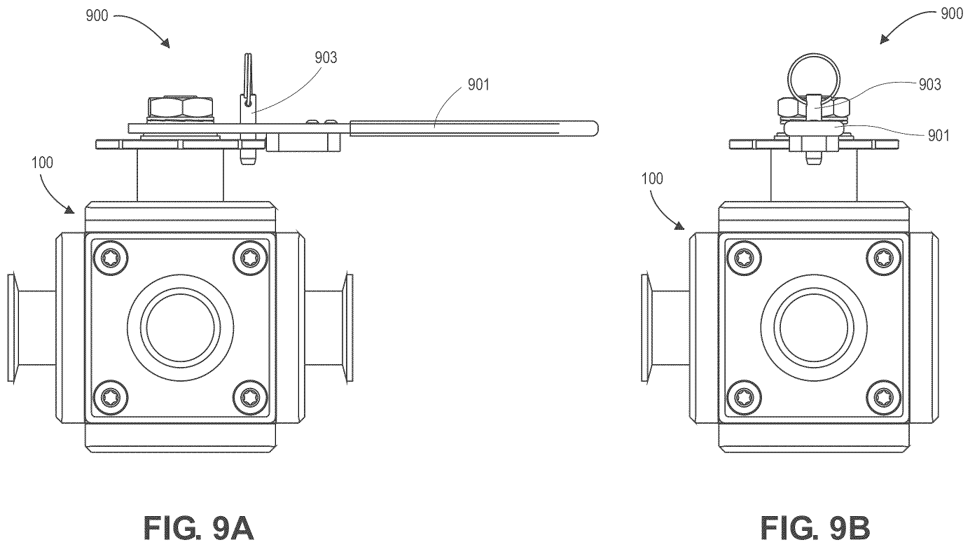

FIGS. 9A-9B illustrate an embodiment of a modular ball valve 100 engaged with an actuation device 900 comprising a handle 901, and quick release pin 903 that may be inserted through a hole in the handle and extend into a corresponding slot of an adaptor extending from and secured to the top end cap. Quick release pin 903 can be used for locking the handle in place and preventing accidental actuation. Rather than a pin, another actuation-prevention device may be used such as an appropriately sized keyed or combination lock for lock-out-tag-out safety practices.

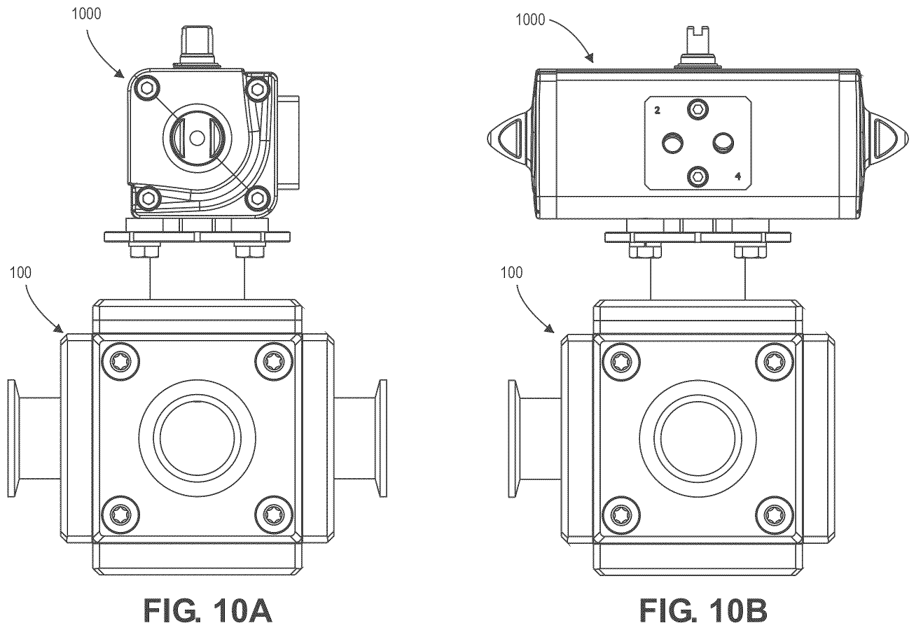

FIGS. 10A-10B illustrate an embodiment of a modular ball valve 100 engaged with an actuation device 1000 comprising a pneumatic actuator.

### EXAMPLES

To test thermal properties of a thermally conductive grease of the embodiments as applied to a modular valve of the embodiments, 11 experiments were conducted using various thermally conductive grease compositions. In each experiment, a respective composition of grease was applied and disposed between the ball and corresponding valve surfaces as described in the embodiments above, with a heater jacket placed around the valve to heat the valve to temperatures of 60° C., 100° C., 150° C., and 200° C. in successive stages while the valve was connected to a vacuum system and exposed to vacuum. The grease compositions of the for each of the 11 experiments are shown below in Table 1.

| EXPERIMENT | |
|---|---|
| NO. | GREASE COMPOSITION |
| Comparative | Grease 1 (grease only; no metal/alloy powder) |
| Composition 1 | |
| Comparative | Grease 2 (grease only; no metal/alloy powder) |
| Composition 2 | |
| Comparative | Grease 3 (grease only; no metal/alloy powder) |
| Composition 3 | |
| Exemplary | Grease 1 and 316 SS powder (<44 micron) 1:2 mix ratio |
| Thermally | |
| Conductive | |
| Grease | |
| Embodiment 1 | |
| Exemplary | Grease 2 grease and 316 SS powder (<44 micron) 1:2 mix ratio |
| Thermally | |
| Conductive | |
| Grease | |
| Embodiment 2 | |
| Exemplary | Grease 3 and 316 SS powder (<44 micron) 1:3 mix ratio |
| Thermally | |
| Conductive | |
| Grease | |
| Embodiment 3 | |
| Exemplary | Grease 3 and 316 SS powder (<44 micron) 1:3 mix ratio |
| Thermally | |
| Conductive | |
| Grease | |
| Embodiment 4 | |
| Exemplary | Grease 3 and 316 SS powder (<44 micron) 1:2.5 mix ratio |
| Thermally | |
| Conductive | |
| Grease | |
| Embodiment 5 | |
| Exemplary | Grease 3 and 316 SS powder (15 micron) 1:2 mix ratio |
| Thermally | |
| Conductive | |
| Grease | |
| Embodiment 6 | |
| Exemplary | Grease 3 and 316 SS powder (15 micron) 1:3 mix ratio |
| Thermally | |
| Conductive | |
| Grease | |
| Embodiment 7 | |
| Exemplary | Grease 3 and 316 SS powder (44-149 micron) 1:1 mix ratio |
| Thermally | |
| Conductive | |
| Grease | |
| Embodiment 8 | |

The temperatures of the valve's outer surface, the top of ball's bore, the bottom of the ball's bore, as well as the ambient air temperature were measured with corresponding thermocouples and recorded. Thermal effectiveness of each thermally conductive grease composition was determined by measuring the time it took for the average temperature of the ball bore to reach the target temperature. After thermal cycling, the test valve was disassembled, and the state of the grease or grease and powder mixture was observed for significant changes in viscosity.

The first objective of the testing was to determine the effectiveness of commercially available, conventional vacuum greases at conducting heat to the valve's ball. Tests nos. 1-6 were conducted using three different high vacuum greases, both in their pure form and after being mixed with a 316 stainless steel alloy powder having particle sizes that were less than 44 micron, and in a 1:2 ratio of grease to powder by weight, except the mixture for experiment no. 6 included a composition with 1:3 grease to powder by weight.

While commercially available vacuum grease improves the heat transfer to the ball, mixing those greases with stainless-steel powder significantly improves the heat transfer to the ball. As a comparison, in the case where no grease at all is placed between the heat-thru components of a ball valve and the valve's ball, it took between approximately 75 to 85 minutes for the ball to reach the setpoint temperature. When the unmodified, off-the-shelf volumes of commercial vacuum grease were used, the time for the ball to reach the setpoint temperature was reduced to approximately 55 to 65 minutes, constituting a 25%-30% time reduction. Meanwhile, when the mixtures of grease and stainless-steel powder were used, the time for the ball to reach the setpoint temperature was further reduced to approximately 45 to 55 minutes, a 35%-45% improvement. As for a comparison of various unmodified commercial grease compositions, no significant time difference for the ball to reach the setpoint temperature were observed, nor was there a significant time difference observed between the mixtures of grease and stainless-steel powder.

Thermal performance of the compositional ratios of grease to metal/alloy powder such as 1:2.5 and 1:3 by weight was tested and compared to the use of a composition having 1:2 ratio of grease to powder by weight. It was observed that the ball valve with the 1:2.5 mixture applied thereto, reached the setpoint temperature slightly faster than the ball valve with the 1:2 mixture over all measured temperature ranges. However, for the ball valve with the 1:3 mixture applied thereto, the thermal performance was either slower than or the same as the 1:2 mixture, depending on the temperature range of the test. While not limited to any particular theory, it is believed that increasing the amount of powder in the mixture increased thermal performance of the corresponding ball valve to a point, but putting too much powder in the mixture has a negative effect. Additionally, as more powder was added to the mixtures with the vacuum grease, the fluid consistency of the mixtures was lost, and the mixtures became more putty/clay-like. Thus, while not limited to any particular theory, it is believed that as the resulting mixture is too thick, it is unable to penetrate into the surface irregularities of the mating components of the ball valve, thereby losing surface area for heat transfer.

The effect of the increased viscosity of the mixture for the thermal vacuum grease has a negative effect on the mechanical suitability of the mixture. Although the 1:2.5 mixture had better thermal performance, it suffered mechanically from the additional powder content, as it did not adhere to surfaces and was prone to tearing when subjected to relative motion between contacting surfaces of the corresponding ball valve on which it was applied.

Tests were also conducted to measure effects of particle size of the stainless-steel powder on thermal performance. On mixing metal alloy particle of different sizes with conventional vacuum grease, it was immediately observed that the particle size has a significant effect on the viscosity of the mixture. When the smaller powder size was mixed with vacuum grease in a 1:2 ratio by weight, the viscosity was essentially unchanged from the unmodified form of the grease. When the larger power size was mixed with vacuum grease in a 1:2 ratio by weight, the resulting mixture resembled wet beach sand and was unable to be extruded through an application syringe. An additional mixture using the smaller powder (less than about 15 micron) was prepared in a 1:3 mixture ratio, and the mixture ratio for the larger powder (less than about 45 micron) was reduced to 1:1. The smaller powder mixed in a 1:3 ratio had a viscosity very similar to the medium powder mixed in a 1:2 ratio. The 1:1 mixture ratio of the large powder appeared thicker than the 1:2 mixture of the medium powder, but it was still extrudable from the application syringe. The mixture containing the smaller powder size in a 1:3 ratio had better thermal performance over all temperature ranges, reaching the set point temperatures approximately 5 minutes faster than the other formulations. Like the 1:2 ratio mixture of medium size powder, mixture containing the smaller powder size in a 1:3 ratio retained its fluid nature after thermal cycling, and since its viscosity is very similar to the viscosity of the 1:2 ratio mixture of medium sized powder.

While the present teachings have been illustrated with respect to one or more implementations, alterations and/or modifications may be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages may be added or existing structural components and/or processing stages may be removed or modified.

Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Terms of relative position as used in this application are defined based on a plane parallel to the conventional plane or working surface of a workpiece, regardless of the orientation of the workpiece.

As used herein, the phrase “one or more of”, for example, A, B, and C means any of the following: either A, B, or C alone; or combinations of two, such as A and B, B and C, and A and C; or combinations of three A, B and C.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A modular ball valve, comprising:
a valve body frame comprising an inner surface and an outer surface, the outer surface comprising at least two side faces, a top face and a bottom face, wherein the at least two side faces comprise a first side face and a second side face;
a first end cap comprising a first seat and secured to the first side face;
a second end cap comprising a second seat and secured to the second side face;
a ball disposed between the first seat and the second seat and comprising a top outer-diameter surface, a bottom outer-diameter surface, and a valve stem slot;
a bottom end cap secured to the bottom face of the valve body frame;
a top end cap comprising a through hole and secured to the top face of the valve body frame, wherein the through hole extends between a proximal surface of the top end cap and a distal surface of the top end cap; and
a valve stem comprising a distal end, a proximal end and a stem body frame that extends between the distal and the proximal end, wherein the proximal end is engaged with the valve stem slot, and wherein the stem body frame extends through the through hole.

2. The valve of claim 1, wherein any one of the first end cap, second end cap, bottom end cap and top end cap can be separately removed from the valve body frame and replaced with a respective one of a replacement.

3. The valve of claim 1, wherein the bottom end cap further comprises a bottom distal-facing heat transfer surface that extends substantially concentrically with at least a bottom outer-diameter surface of the ball and is separated from the bottom outer-diameter surface by a bottom gap,
wherein the top end cap further comprises a top proximal-facing heat transfer surface that extends substantially concentrically with at least an upper outer-diameter surface of the ball and is separated from the upper outer-diameter surface by a top gap.

4. The valve of claim 3, wherein the bottom end cap comprises a bottom body port end cap.

5. The valve of claim 4, wherein the bottom body port end cap comprises a bore therethrough.

6. The valve of claim 5, wherein the bottom distal-facing heat transfer surface comprises an annular surface disposed concentric with a diameter of the bore.

7. The valve of claim 3, further comprising a volume of thermally conductive grease substantially occupying at least one of the bottom gap and the top gap, substantially contacting at least one of the bottom distal-facing heat transfer surface and the top proximal-facing heat transfer surface, and substantially contacting at least one of the bottom outer-diameter of the ball and the upper outer-diameter surface of the ball.

8. The valve of claim 7, wherein the thermally conductive grease comprises a mixture of a vacuum grease and a powder comprising a metal, a metal alloy or both.

9. The valve of claim 8, wherein the metal alloy powder comprises a plurality of metal particles, metal alloy particles, or both.

10. The valve of claim 9, wherein the plurality of metal alloy particles comprise a particle size of from about 4 microns to about 150 microns.

11. The valve of claim 9, wherein the thermally conductive grease composition comprises a grease-to-particle ratio of from 1:1 to about 1:3 by weight.

12. The valve of claim 9, wherein the thermally conductive grease composition comprises a grease-to-particle ratio of from 1:1 to about 1:4 by weight.

13. The valve of claim 7, wherein the metal alloy comprises stainless steel.

14. The valve of claim 1, wherein the valve is a 3-way valve.

15. The valve of claim 1, wherein the valve is a 4-way valve.

16. The valve of claim 1, wherein the valve is a 5-way valve.

17. The valve of claim 1, wherein the valve body frame comprises a cube-shaped valve body.

18. The valve of claim 16, wherein the cube-shaped valve body frame comprises 6 side faces.

19. The valve of claim 17, wherein at least one of the first end cap and the second end cap comprises a blank end cap fastened to one of the 6 faces.

20. The valve of claim 1, wherein the valve stem comprises a thermally insulating stem.

21. The valve of claim 1, wherein the stem body frame comprises at least a hollow portion.

22. The valve of claim 1, wherein the stem body frame comprises an inner diameter, an outer diameter and a sidewall that extends from the inner diameter to the outer diameter.

23. The valve of claim 1, wherein the stem body frame comprises a distal portion and a proximal portion.

24. The valve of claim 1, wherein the stem's distal end is welded to the stem body frame's distal portion.

25. The valve of claim 1, wherein the stem's proximal end extends from the stem body frame's proximal portion and wherein the proximal end and stem body frame comprise a single, machined part.

26. The valve of claim 1, wherein the ball comprises a fully ported ball.

27. The valve of claim 26, wherein the fully ported ball comprises an I-port, x-port, L-port, T-port, vertical L-port, vertical T-port, double L-port, and double T-port.

28. The valve of claim 1, wherein each of the valve body frame, first end cap, second end cap, ball, bottom end cap, top end cap and stem substantially comprise a metal alloy.

29. The valve of claim 1, further comprising a handle attached to the distal end of the stem and adapted to transfer rotational motion to the ball.

30. The valve of claim 1, wherein the inner surface comprises at least two inner side faces, an inner top face and an inner bottom face.

31. The valve of claim 30, wherein the valve body frame further comprises a plurality of openings that each extends from the inner surface to the outer surface.

32. The valve of claim 31, wherein the plurality of openings comprises a top opening that extends from the inner top face to the top face, a bottom opening that extends from the inner bottom surface to the bottom face, and at least two side openings comprising a first side opening that extends from a first of the two inner side faces to a first of the two side faces and a second side opening that extends from a second of the two inner side faces to a second of the two side faces.

33. The valve of claim 1, further comprising a lower bearing disposed at a proximal portion of the top end cap on a sidewall portion of the through hole, an upper bearing disposed at a distal portion of the top end cap on the sidewall portion of the through hole, an O-ring disposed between the upper bearing and the lower bearing; a wave spring washer disposed distal to the upper bearing and a retaining ring disposed distally to the wave spring washer, wherein the stem extends through the lower bearing, O-ring, upper bearing, wave spring washer and retaining ring.

34. The valve of claim 1, wherein at least one of the first side face, the second side face, the top face and the bottom face comprises fastener accepting holes and wherein at least one of the top end cap, bottom end cap, first end cap and second end cap comprises fastener through holes that align with the fastener accepting holes.

35. The valve of claim 1, further comprising a mounting adaptor secured to the top end cap.

36. The valve of claim 6, wherein the top proximal-facing heat transfer surface comprises an annular surface disposed concentric with a diameter of the through hole.

37. The valve of claim 1, further comprising an actuator attached to the distal end of the stem and adapted to transfer rotational motion to the ball.

38. The valve of claim 1, further comprising a fastening nut, wherein the distal end of the stem comprises a threaded portion and the stem is secured to the top end cap with the fastening nut threaded along the threaded portion of the stem.

39. A method for making a modular ball valve, comprising:
providing a valve body frame comprising at least two side faces, a top face and a bottom face;
securing a first end cap comprising a first seat to a first one of the at least two side faces of the valve body frame;
securing a second end cap comprising a second seat to a second one of the at least two side faces of the valve body frame;
securing a ball between the first seat and the second seat;
securing a bottom end cap to the bottom face of the valve body frame, wherein the bottom end cap comprises a bottom distal-facing heat transfer surface that extends substantially concentrically with at least a portion of bottom outer-diameter of the ball and is separated from the at least the portion of the bottom outer-diameter surface by a bottom gap;
securing a top end cap comprising a through hole to the top face of the valve body frame, wherein the top end cap comprises a top proximal-facing heat transfer surface that substantially aligns concentrically with at least an upper outer-diameter surface of the ball and is separated from the upper outer-diameter surface by a top gap;
inserting a valve stem through the through hole, the valve stem comprising a distal end, a proximal end and a stem body that extends between the distal and the proximal end, wherein the proximal end is engaged with the valve stem slot, and wherein the stem body extends through the through hole; and
delivering a volume of thermally conductive grease to substantially occupy at least one of the bottom gap and the top gap, wherein the thermally conductive grease comprises a mixture of a vacuum grease and a metal, a metal alloy or both.

40. A thermally conductive grease composition, comprising:
a mixture comprising a vacuum grease and a powder comprising a metal, a metal alloy or both.

41. The thermally conductive grease of claim 40, wherein the metal alloy powder comprises a plurality of metal alloy particles.

42. The thermally conductive grease of claim 41, wherein the plurality of particles comprise a particle size of from about 4 microns to about 150 microns.

43. The thermally conductive grease of claim 42, wherein the plurality of particles comprise a particle size of about 15 microns.

44. The thermally conductive grease of claim 40, wherein the thermally conductive grease composition comprises a grease-to-particle ratio of from 1:1 to about 1:3 by weight.

45. The thermally conductive grease of claim 40, wherein the thermally conductive grease composition comprises a grease-to-particle ratio of from 1:1 to about 1:4 by weight.

46. A stem subassembly kit, comprising:
a top end cap comprising a through hole, wherein the top end cap comprises a top proximal-facing heat transfer surface that, when attached to a ball valve, substantially aligns concentrically with at least an upper outer-diameter surface of the ball and is separated from the upper outer-diameter surface by a top gap, and wherein the through hole extends between a proximal surface of the top end cap and a distal surface of the top end cap;
a valve stem comprising a distal end, a proximal end and a stem body that extends between the distal and the proximal end, wherein the stem body extends through the through hole, and wherein the valve stem is connected to the top end cap; and
a volume of thermally conductive grease comprising a mixture of a vacuum grease and powder, the powder comprising a metal, a metal alloy or both.

47. The stem subassembly kit of claim 46, further comprising:
a lower bearing disposed at a proximal portion of the top end cap on a sidewall portion of the through hole,
an upper bearing disposed at a distal portion of the top end cap on the sidewall portion of the through hole,
an O-ring disposed between the upper bearing and the lower bearing;
a wave spring washer disposed distal to the upper bearing, and
a retaining ring disposed distally to the wave spring washer,
wherein the stem extends through the lower bearing, O-ring, upper bearing, wave spring washer and retaining ring.

48. The stem subassembly kit of claim 46, further comprising a fastening nut, wherein the distal end of the stem comprises a threaded portion and the stem is secured to the top end cap with the fastening nut threaded along the threaded portion of the stem.

49. The stem subassembly kit of claim 46, wherein the thermally conductive grease comprises a mixture of a vacuum grease and a metal alloy powder.

50. The stem subassembly kit of claim 49, wherein the metal alloy powder comprises a plurality of metal alloy particles.

51. The stem subassembly kit of claim 50, wherein the plurality of particles comprise a particle size of from about 4 microns to about 150 microns.

52. The stem subassembly kit of claim 50, wherein the plurality of particles comprise a particle size of about 15 microns.

53. The stem subassembly kit of claim 50, wherein the thermally conductive grease composition comprises a grease-to-particle ratio of from 1:1 to about 1:3 by weight.

54. The stem subassembly kit of claim 50, wherein the thermally conductive grease composition comprises a grease-to-particle ratio of from 1:1 to about 1:4 by weight.

55. A method for servicing a modular valve, comprising:
providing a ball valve comprising a stem, a ball, and a top end cap secured to a top face of a valve body frame, wherein the stem is disposed through a through hole of the top end cap and secured to the top end cap;
removing, from the valve body frame, the top end cap with the stem still secured to it;
providing a stem subassembly kit, wherein the stem subassembly kit comprises:
a subassembly kit top end cap comprising a through hole, wherein the through hole extends between a proximal surface of the top end cap and a distal surface of the top end cap, and
further comprising a stem secured to the subassembly top end cap and extending through the through hole; and
securing the stem subassembly kit top end cap to the top face of the valve body frame.

56. The method of claim 55, wherein the subassembly kit top end cap comprises a top proximal-facing heat transfer surface that, when the subassembly kit top end cap is attached to the top face of the valve, substantially aligns concentrically with at least an upper outer-diameter surface of the ball and is separated from the upper outer-diameter surface by a top gap.

57. The method of claim 55, further comprising providing a volume of thermally conductive grease to the top proximal-facing heat transfer surface of the subassembly kit top end cap, wherein the thermally conductive grease comprises a mixture of a vacuum grease and a powder comprising metal particles, metal alloy particles, or both.

58. The method of claim 57, wherein the thermally conductive grease composition comprises a grease-to-particle ratio of from 1:1 to about 1:4 by weight.

59. The method of claim 57, wherein the thermally conductive grease composition comprises a grease-to-particle ratio of from 1:1 to about 1:3 by weight.

60. The valve of claim 1, wherein the end caps are fastened to the valve frame with threaded fasteners comprising recessed fastener heads.

61. The valve of claim 1, further comprising a valve heater jacket comprising a heated surface disposed adjacent to at least one of the top end cap and the bottom end cap.

62. The valve of claim 1, wherein the bottom end cap further comprises a bottom distal-facing heat transfer surface that extends substantially concentrically with at least a bottom outer-diameter surface of the ball and is separated from the bottom outer-diameter surface by a bottom gap.

63. The valve of claim 1, wherein the top end cap further comprises a top proximal-facing heat transfer surface that extends substantially concentrically with at least an upper outer-diameter surface of the ball and is separated from the upper outer-diameter surface by a top gap.
